(19) United States
(12) Patent Application Publication
(10) Pub. No.: US 2011/0145559 A1
(43) Pub. Date: Jun. 16, 2011

(54) SYSTEM AND METHOD FOR CONTROLLING CENTRAL PROCESSING UNIT POWER WITH GUARANTEED STEADY STATE DEADLINES

(76) Inventors: Steven S. Thomson, San Diego, CA (US); Bohuslav Rychlik, San Diego, CA (US); Ali Iranli, San Diego, CA (US); Brian J. Salsbery, Boulder, CO (US); Sumit Sur, Boulder, CO (US); Norman S. Gargash, Boulder, CO (US)

(21) Appl. No.: 12/944,516

(22) Filed: Nov. 11, 2010

Related U.S. Application Data
(60) Provisional application No. 61/286,999, filed on Dec. 16, 2009.

(51) Int. Cl. G06F 9/00

(52) U.S. Cl. 713/100

(57) ABSTRACT

A method of dynamically controlling a central processing unit is disclosed. The method may include determining when a CPU enters a steady state, calculating an optimal frequency for the CPU when the CPU enters a steady state, guaranteeing a steady state CPU utilization, and guaranteeing a steady state CPU utilization deadline.

### RELATED APPLICATIONS

The present application claims priority to U.S. Provisional Patent Application Ser. No. 61/286,999, entitled SYSTEM AND METHOD OF DYNAMICALLY CONTROLLING A CENTRAL PROCESSING UNIT, filed on Dec. 16, 2009, the contents of which are fully incorporated by reference.

### CROSS-REFERENCED APPLICATIONS

The present application is related to, and incorporates by reference, U.S. patent application Ser. No. ______, entitled SYSTEM AND METHOD FOR CONTROLLING CENTRAL PROCESSING UNIT POWER BASED ON INFERRED WORKLOAD PARALLELISM, by Rychlik et al., filed concurrently (Attorney Docket Number 100328U1). The present application is related to, and incorporates by reference, U.S. patent application Ser. No. ______, entitled SYSTEM AND METHOD FOR CONTROLLING CENTRAL PROCESSING UNIT POWER IN A VIRTUALIZED SYSTEM, by Rychlik et al., filed concurrently (Attorney Docket Number 100329U1). The present application is related to, and incorporates by reference, U.S. patent application Ser. No. ______, entitled SYSTEM AND METHOD FOR ASYNCHRONOUSLY AND INDEPENDENTLY CONTROLLING CORE CLOCKS IN A MULTICORE CENTRAL PROCESSING UNIT, by Rychlik et al., filed concurrently (Attorney Docket Number 100330U1). The present application is related to, and incorporates by reference, U.S. patent application Ser. No. ______, entitled SYSTEM AND METHOD FOR CONTROLLING CENTRAL PROCESSING UNIT POWER WITH REDUCED FREQUENCY OSCILLATIONS, by Thomson et al., filed concurrently (Attorney Docket Number 100339U1). The present application is related to, and incorporates by reference, U.S. patent application Ser. No. ______, entitled SYSTEM AND METHOD FOR CONTROLLING CENTRAL PROCESSING UNIT POWER WITH GUARANTEED TRANSIENT DEADLINES, by Thomson et al., filed concurrently (Attorney Docket Number 100340U1). The present application is related to, and incorporates by reference, U.S. patent application Ser. No. ______, entitled SYSTEM AND METHOD FOR DYNAMICALLY CONTROLLING A PLURALITY OF CORES IN A MULTICORE CENTRAL PROCESSING UNIT BASED ON TEMPERATURE, by Sur et al., filed concurrently (Attorney Docket Number 100344U1).

### DESCRIPTION OF THE RELATED ART

Portable computing devices (PDs) are ubiquitous. These devices may include cellular telephones, portable digital assistants (PDAs), portable game consoles, palmtop computers, and other portable electronic devices. In addition to the primary function of these devices, many include peripheral functions. For example, a cellular telephone may include the primary function of making cellular telephone calls and the peripheral functions of a still camera, a video camera, global positioning system (GPS) navigation, web browsing, sending and receiving emails, sending and receiving text messages, push-to-talk capabilities, etc. As the functionality of such a device increases, the computing or processing power required to support such functionality also increases. Further, as the computing power increases, there exists a greater need to effectively manage the processor, or processors, that provide the computing power.

Accordingly, what is needed is an improved method of controlling power within a multicore CPU.

### BRIEF DESCRIPTION OF THE DRAWINGS

In the figures, like reference numerals refer to like parts throughout the various views unless otherwise indicated.

FIG. 1 is a front plan view of a first aspect of a portable computing device (PCD) in a closed position;

FIG. 2 is a front plan view of the first aspect of a PCD in an open position;

FIG. 3 is a block diagram of a second aspect of a PCD;

FIG. 4 is a block diagram of a processing system;

FIG. 5 is a flowchart illustrating a first aspect of a method of dynamically controlling a CPU;

FIG. 6 is a flowchart illustrating a second aspect of a method of dynamically controlling a CPU;

FIG. 7 is a flowchart illustrating a third aspect of a method of dynamically controlling a CPU; and

FIG. 8 is a flowchart illustrating a fourth aspect of a method of dynamically controlling a CPU;

FIG. 9 is a flowchart illustrating a method of calculating an effective CPU utilization;

FIG. 10 is a flowchart illustrating a method of determining whether a filter is responding fast enough;

FIG. 11 is a flowchart illustrating a method of updating a filter during an idle period;

FIG. 12 is a flowchart illustrating a method of updating a filter during a busy period; and

FIG. 13 is a graph plotting CPU utilization versus time.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

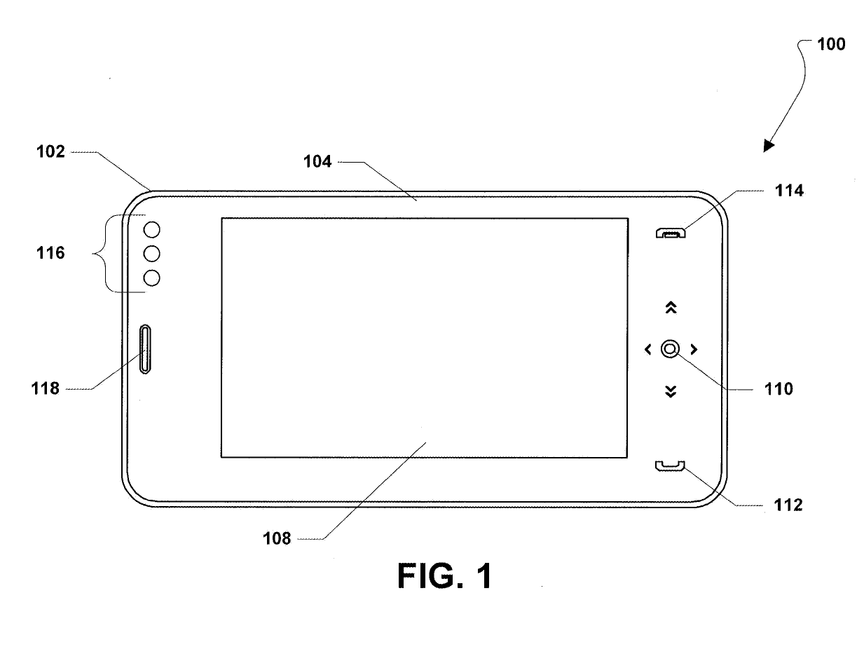

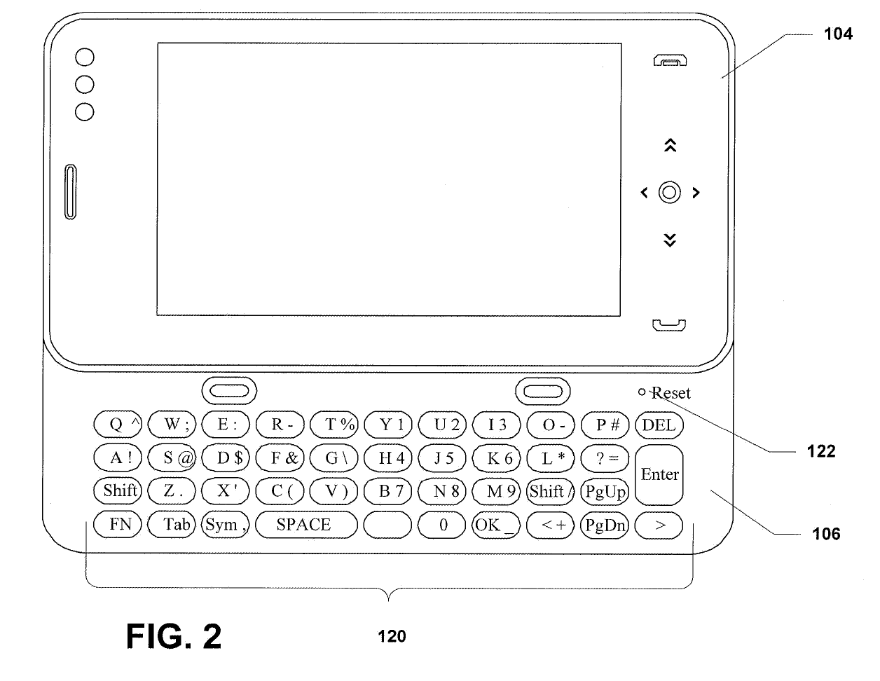

Referring initially to FIG. 1 and FIG. 2, an exemplary portable computing device (PCD) is shown and is generally designated 100. As shown, the PCD 100 may include a housing 102. The housing 102 may include an upper housing portion 104 and a lower housing portion 106. FIG. 1 shows that the upper housing portion 104 may include a display 108. In a particular aspect, the display 108 may be a touch screen display. The upper housing portion 104 may also include a trackball input device 110. Further, as shown in FIG. 1, the upper housing portion 104 may include a power on button 112 and a power off button 114. As shown in FIG. 1, the upper housing portion 104 of the PCD 100 may include a plurality of indicator lights 116 and a speaker 118. Each indicator light 116 may be a light emitting diode (LED).

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106. FIG. 2 further illustrates that the PCD 100 may include a reset button 122 on the lower housing portion 106.

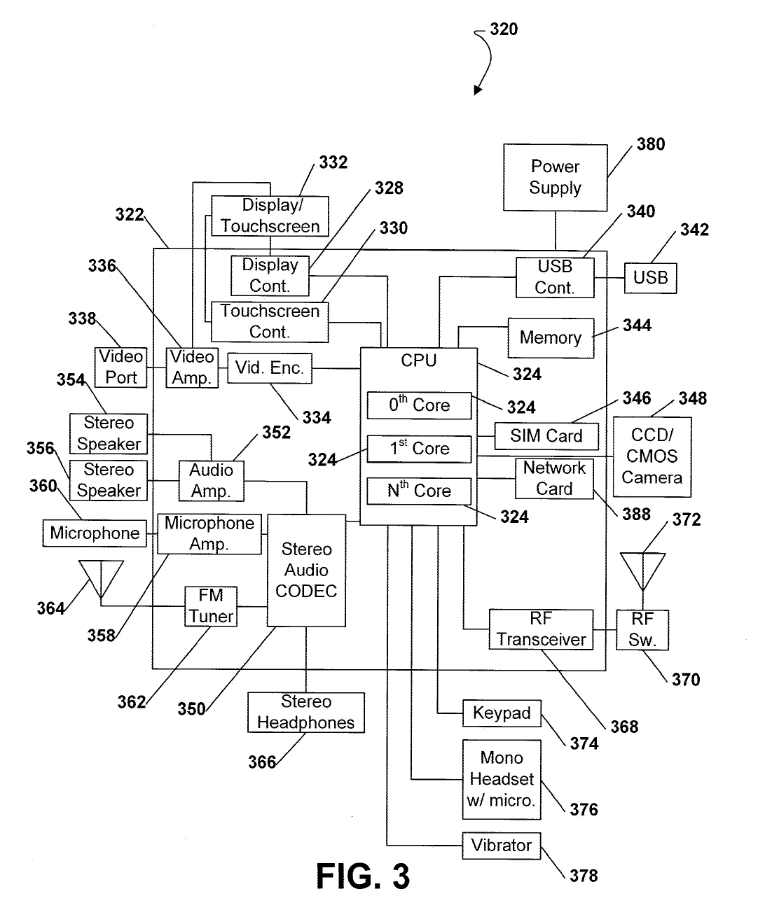

Referring to FIG. 3, an exemplary, non-limiting aspect of a portable computing device (PCD) is shown and is generally designated 320. As shown, the PCD 320 includes an on-chip system 322 that includes a multicore CPU 324. The multicore CPU 324 may include a zeroth core 325, a first core 326, and an Nth core 327.

As illustrated in FIG. 3, a display controller 328 and a touch screen controller 330 are coupled to the multicore CPU 324. In turn, a touch screen display 332 external to the on-chip system 322 is coupled to the display controller 328 and the touch screen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the multicore CPU 324. Further, a video amplifier 336 is coupled to the video encoder 334 and the touch screen display 332. Also, a video port 338 is coupled to the video amplifier 336. As depicted in FIG. 3, a universal serial bus (USB) controller 340 is coupled to the multicore CPU 324. Also, a USB port 342 is coupled to the USB controller 340. A memory 344 and a subscriber identity module (SIM) card 346 may also be coupled to the multicore CPU 324. Further, as shown in FIG. 3, a digital camera 348 may be coupled to the multicore CPU 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the multicore CPU 324. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the multicore CPU 324. An RF switch 370 may be coupled to the RF transceiver 368 and an RF antenna 372. As shown in FIG. 3, a keypad 374 may be coupled to the multicore CPU 324. Also, a mono headset with a microphone 376 may be coupled to the multicore CPU 324. Further, a vibrator device 378 may be coupled to the multicore CPU 324. FIG. 3 also shows that a power supply 380 may be coupled to the on-chip system 322. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the touch screen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 344 as computer program instructions. These instructions may be executed by the multicore CPU 324 in order to perform the methods described herein. Further, the multicore CPU 324, the memory 344, or a combination thereof may serve as a means for executing one or more of the method steps described herein in order to dynamically control the power of each CPU, or core, within the multicore CPU 324.

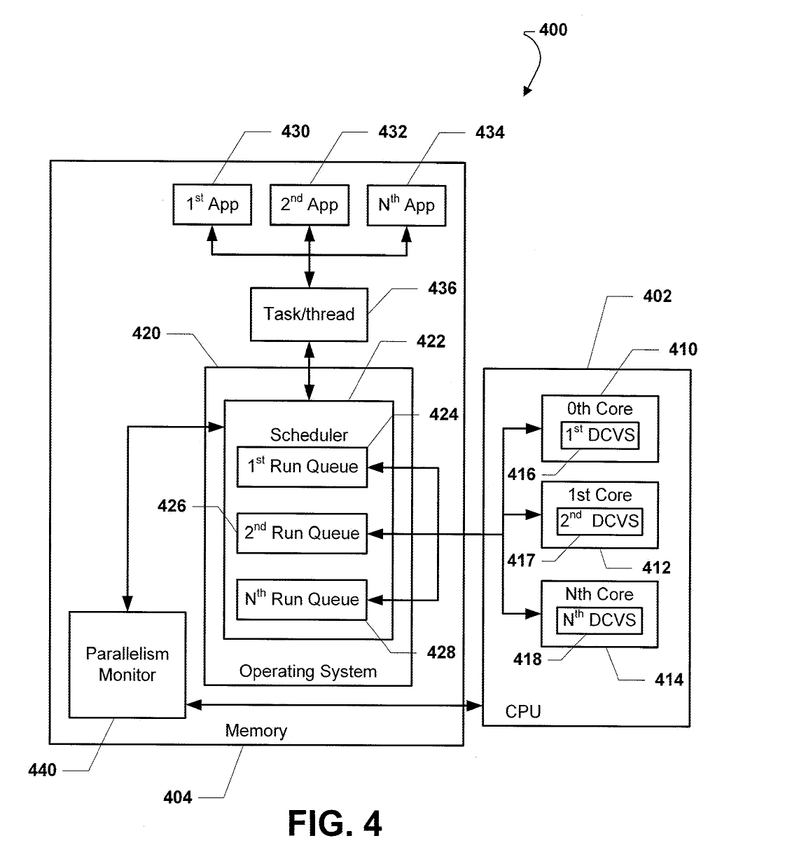

Referring to FIG. 4, a processing system is shown and is generally designated 500. In a particular aspect, the processing system 500 may be incorporated into the PCD 320 described above in conjunction with FIG. 3. As shown, the processing system 500 may include a multicore central processing unit (CPU) 402 and a memory 404 connected to the multicore CPU 402. The multicore CPU 402 may include a zeroth core 410, a first core 412, and an Nth core 414. The zeroth core 410 may include a zeroth dynamic clock and voltage scaling (DCVS) algorithm 416 executing thereon. The first core 412 may include a first DCVS algorithm 417 executing thereon. Further, the Nth core 414 may include an Nth DCVS algorithm 418 executing thereon. In a particular aspect, each DCVS algorithm 416, 417, 418 may be independently executed on a respective core 412, 414, 416.

Moreover, as illustrated, the memory 404 may include an operating system 420 stored thereon. The operating system 420 may include a scheduler 422 and the scheduler 422 may include a first run queue 424, a second run queue 426, and an Nth run queue 428. The memory 404 may also include a first application 430, a second application 432, and an Nth application 434 stored thereon.

In a particular aspect, the applications 430, 432, 434 may send one or more tasks 436 to the operating system 420 to be processed at the cores 410, 412, 414 within the multicore CPU 402. The tasks 436 may be processed, or executed, as single tasks, threads, or a combination thereof. Further, the scheduler 422 may schedule the tasks, threads, or a combination thereof for execution within the multicore CPU 402. Additionally, the scheduler 422 may place the tasks, threads, or a combination thereof in the run queues 424, 426, 428. The cores 410, 412, 414 may retrieve the tasks, threads, or a combination thereof from the run queues 424, 426, 428 as instructed, e.g., by the operating system 420 for processing, or execution, of those task and threads at the cores 410, 412, 414.

FIG. 4 also shows that the memory 404 may include a parallelism monitor 440 stored thereon. The parallelism monitor 440 may be connected to the operating system 420 and the multicore CPU 402. Specifically, the parallelism monitor 440 may be connected to the scheduler 422 within the operating system 420.

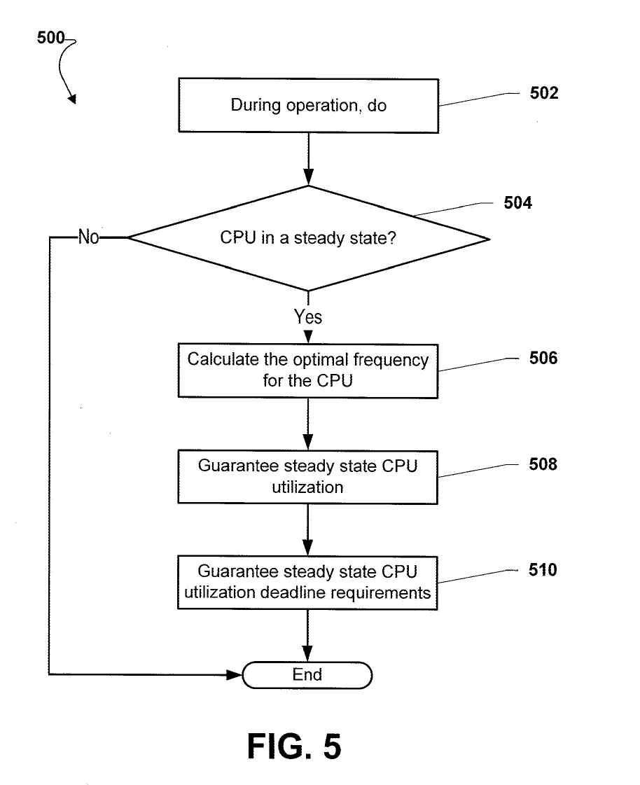

FIG. 5 illustrates a first aspect of a method of dynamically controlling the power of a central processing unit is shown and is generally designated 500. Beginning at block 502, during operation, the following steps may be performed. At decision 504, a controller, e.g., a dynamic clock and voltage scaling (DCVS) algorithm, may determine whether the CPU is in a steady state. If not, the method 500 may end.

Otherwise, the method 500 may proceed to block 506 and the controller may calculate the optimal frequency for the CPU. At block 508, the DCVS may guarantee a steady state CPU utilization. Further, at block 510, the DCVS may guarantee a steady state CPU utilization deadline. Thereafter, the method 500 may end.

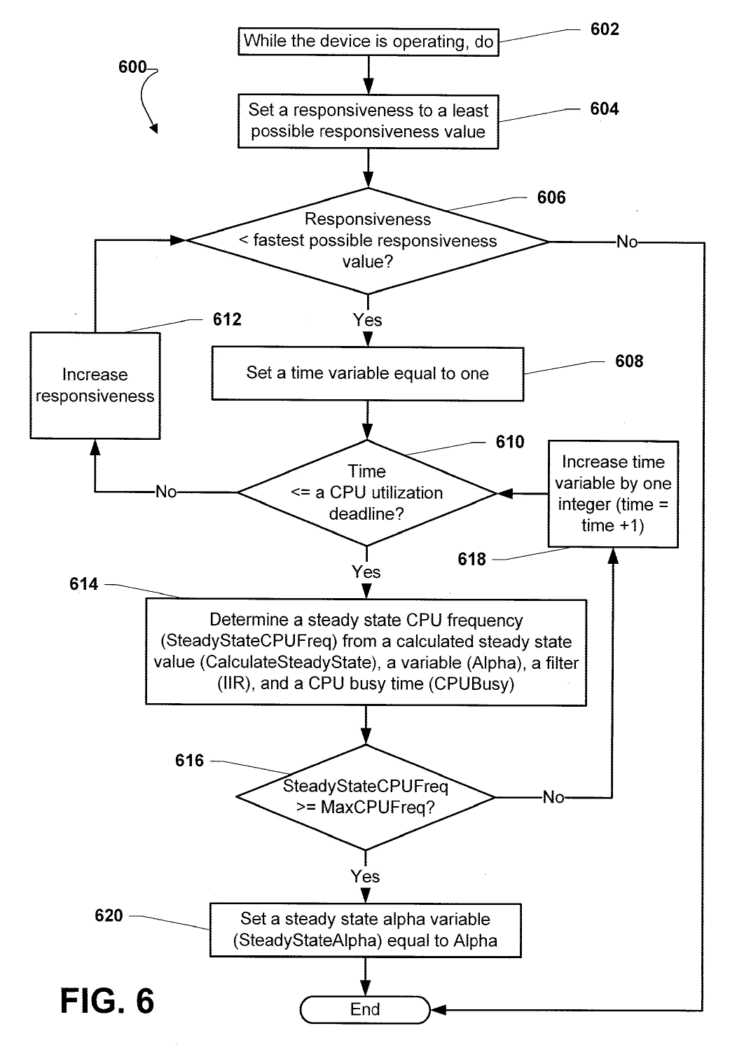

Referring to FIG. 6, a second aspect of a method of dynamically controlling the power of a central processing unit is shown and is generally designated 600. The method 600 may commence at block 602 with a do loop in which when device is powered on or whenever the responsiveness guarantees are changed, the following steps may be performed.

At block 604, a power controller, e.g., a dynamic clock and voltage scaling (DCVS) algorithm, may set a responsiveness to a least possible responsiveness value. At decision 606, the power controller may determine whether the responsiveness is less than the fastest possible responsiveness value. If not, the method 600 may end. Conversely, if the responsiveness is less than the fastest possible responsiveness, the method 600 may move to block 608. At block 608, the power controller may set a time variable equal to one. Thereafter, at decision 610, the power controller may determine whether the time is less than or equal to a CPU utilization deadline. If not, the method may move to block 612, and the power controller may increase the responsiveness. Then, the method 600 may return to decision 606 and the method 600 may proceed as described herein.

Returning to decision 610, if the time is less than or equal to the CPU utilization deadline, the method may proceed to block 614 and the power controller may determine a steady state CPU frequency (SteadyStateCPUFreq) based on a responsiveness value, a filter (IIR), and a CPU busy time (CPUBusy).

Then, at decision 616, the power controller may determine whether the SteadyStateCPUFreq is greater than or equal to a maximum CPU frequency (MaxCPUFreq). If the SteadyStateCPUFreq is not greater than or equal to the MaxCPUFreq, the method may move to block 618 and the power controller may increase the time variable by one integer (time=time+1). Thereafter, the method 600 may return to decision 610 and the method 600 may continue as described herein.

Returning to decision 616, if the SteadyStateCPUFreq is greater than or equal to the MaxCPUFreq, the method 600 may continue to block 620 and the power controller may set a steady state responsiveness variable (SteadyStateResp) equal to the responsiveness value. The method 600 may then end.

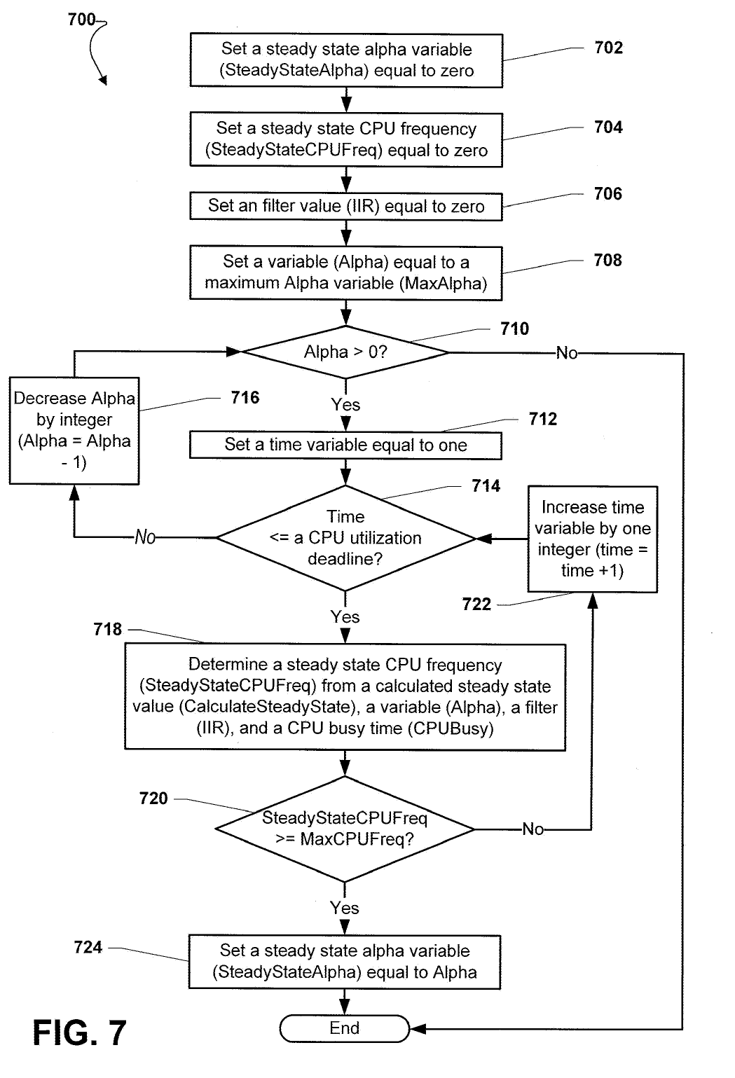

Referring to FIG. 7, a third aspect of a method of dynamically controlling the power of a central processing unit is shown and is generally designated 700. The method 700 may commence at block 702. At block 702, a power controller, e.g., a dynamic clock and voltage scaling (DCVS) algorithm, may set a steady state alpha variable (SteadyStateAlpha) equal to zero. At block 704, the power controller may set a steady state CPU frequency (SteadyStateCPUFreq) equal to zero. Further, at block 706, the power controller may set an infinite impulse response (IIR) filter value equal to zero. At block 708, the power controller may set a variable (Alpha) equal to a maximum Alpha variable (MaxAlpha).

Moving to decision 710, the power controller may determine whether the Alpha is greater than zero. If not, the method 700 may end. Conversely, if the Alpha is greater than zero, the method 700 may move to block 712. At block 712, the power controller may set a time variable equal to one. Thereafter, at decision 714, the power controller may determine whether the time is less than or equal to a CPU utilization deadline. If not, the method may move to block 716, and the power controller may decrease the Alpha by one integer (Alpha=Alpha−1). Then, the method 700 may return to decision 710 and the method 700 may proceed as described herein.

Returning to decision 714, if the time is less than or equal to the CPU utilization deadline, the method may proceed to block 718 and the power controller may determine a steady state CPU frequency (SteadyStateCPUFreq) based on a variable (Alpha), a filter (IIR), and a CPU busy time (CPUBusy). Then, at decision 720, the power controller may determine whether the SteadyStateCPUFreq is greater than or equal to a maximum CPU frequency (MaxCPUFreq). If the SteadyStateCPUFreq is not greater than or equal to the MaxCPUFreq, the method may move to block 722 and the power controller may increase the time variable by one integer (time=time+1). Thereafter, the method 700 may return to decision 714 and the method 700 may continue as described herein.

Returning to decision 720, if the SteadyStateCPUFreq is greater than or equal to the MaxCPUFreq, the method 700 may continue to block 724 and the power controller may set a steady state alpha variable (SteadyStateAlpha) equal to Alpha. The method 700 may then end.

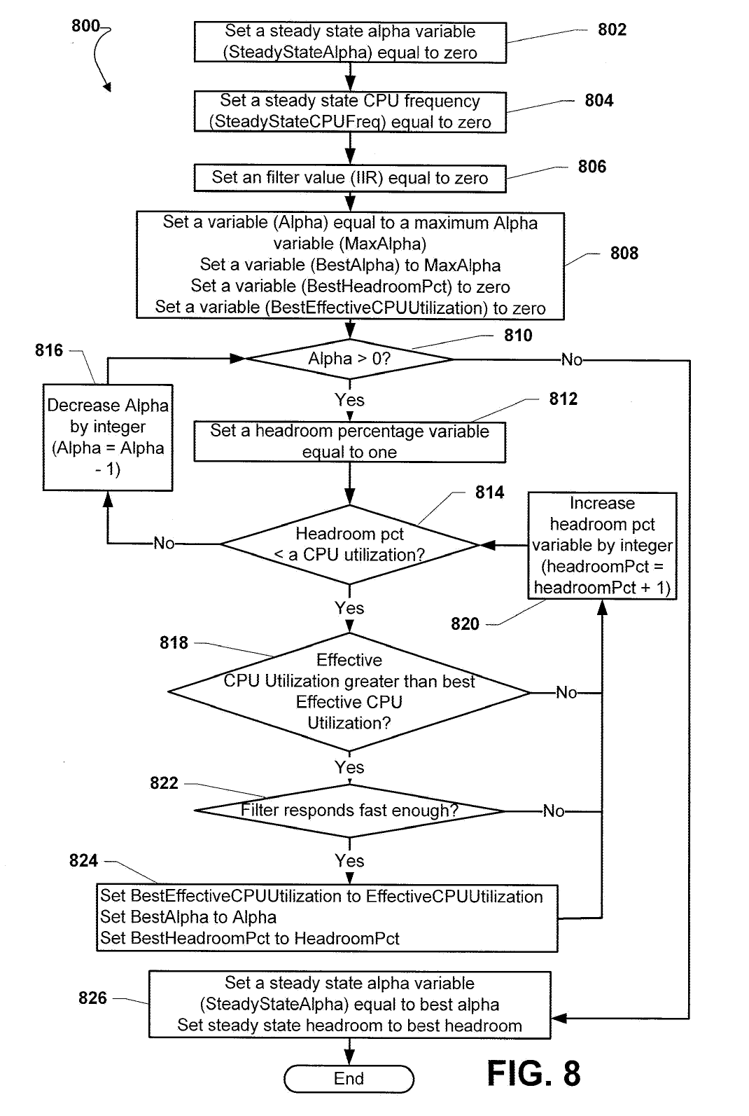

FIG. 8 illustrates a fourth aspect of a method of dynamically controlling the power of a central processing unit is shown, generally designated 800. The method 800 may commence at block 802. At block 802, a power controller, e.g., a dynamic clock and voltage scaling (DCVS) algorithm, may set a steady state alpha variable (SteadyStateAlpha) equal to zero. At block 804, the power controller may set a steady state CPU frequency (SteadyStateCPUFreq) equal to zero. Further, at block 806, the power controller may set an infinite impulse response (IIR) filter value equal to zero. At block 808, the power controller may set a variable, Alpha, equal to a maximum Alpha value, MaxAlpha. At block 808, another variable, BestAlpha, may also be set to MaxAlpha. Also, at block 808, another variable, BestHeadroomPct, may be set to zero and a variable, BestEffectiveCPUUtilization, may be set to zero.

Moving to decision 810, the power controller may determine whether the Alpha is greater than zero. If not, the method 800 may proceed to block 826 and the controller may set a steady state alpha variable (SteadyStateAlpha) equal to a best alpha value. Also, the controller may set a steady state headroom variable to a best headroom value. Thereafter, the method 800 may end.

Returning to decision 810, if the Alpha is greater than zero, the method 800 may move to block 812. At block 812, the power controller may set a headroom percentage (HeadroomPCT) variable equal to one. Thereafter, at decision 814, the power controller may determine whether the headroom percentage is less than a CPU utilization. If not, the method may move to block 816, and the power controller may decrease the Alpha by one integer (Alpha=Alpha−1). Then, the method 800 may return to decision 810 and the method 800 may proceed as described herein.

Returning to decision 814, if the headroom percentage is less than the CPU utilization, the method may proceed to block 818 and the power controller may determine whether an effective CPU utilization is greater than a best effective CPU utilization. If not, the method 800 may move to block 820 and the power controller may increase the headroom percentage variable by one integer (HeadroomPCT=HeadroomPCT+1). Thereafter, the method 800 may return to decision 814 and the method 800 may continue as described herein.

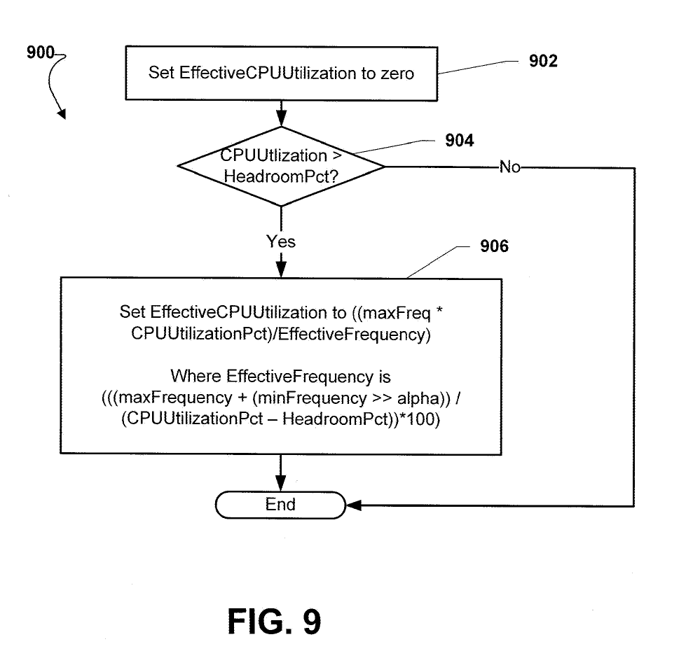

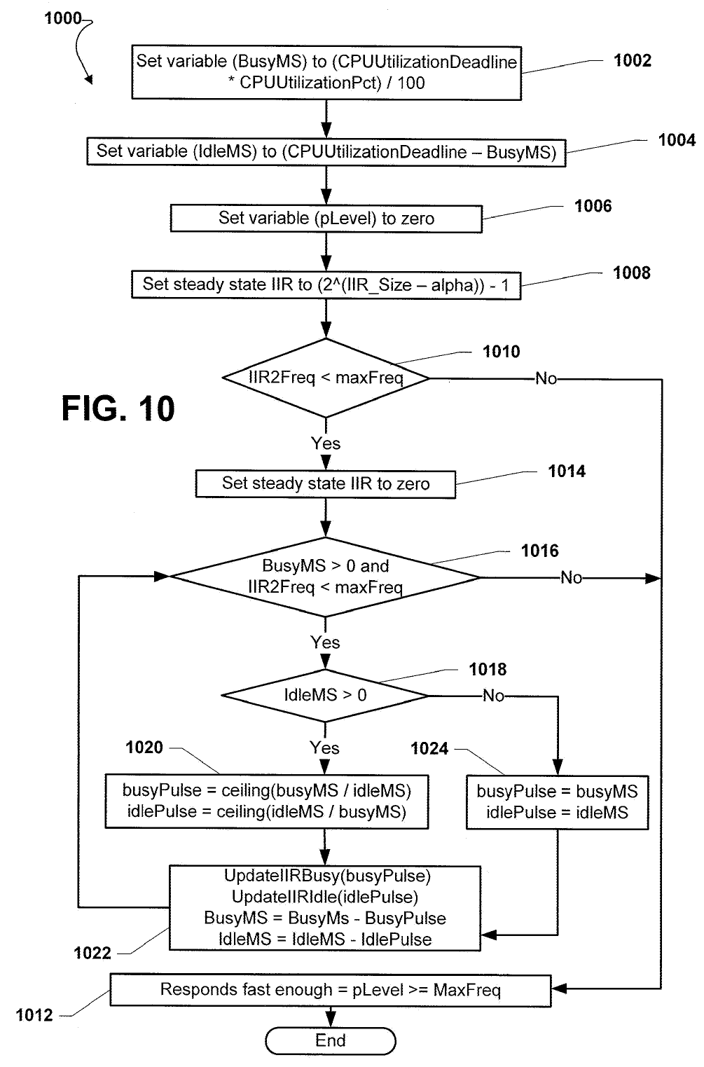

Returning to decision 818, if the effective CPU utilization is greater than the best effective CPU utilization, the method 800 may continue to decision 822 and the controller may determine whether the filter is responding fast enough, e.g., using the method steps shown in FIG. 10, described below. If not, the method 800 may return to block 820 and continue as described herein. Otherwise, the method 800 may proceed to block 824 and the controller may set the BestEffectiveCPUUtilization equal to an EffectiveCPUUtilization. In a particular aspect, the EffectiveCPUUtilization may be determined as shown in FIG. 9, described below. At block 824, BestAlpha may be set the value of Alpha and BestHeadRoomPct may be set to the value of HeadroomPCT. From block 824, the method 800 may return to block 820 and the method 800 may then, proceed as described herein.

Referring now to FIG. 9, a method of calculating an EffectiveCPUUtilization is shown and commences at block 902. At block 902, the EffectiveCPUUtilization is set equal to zero. Next, at decision 904, it may be determined whether the current CPUUtilization is greater than a headroom percentage (HeadroomPCT). If not, the method 900 may end. Otherwise, the method 900 may proceed to block 906 and the EffectiveCPUUtilization may be determined, e.g., using the following formula:

EffectiveCPUUtilization=((maxFreq*CPUUtilizationPct)/EffectiveFrequency
where,
maxFreq=a maximum frequency,
CPUUtilizationPct=a current CPU utilization percentage, and
EffectiveFrequency=an effective frequency determined from the formula below:

EffectiveFrequency=(((maxFreq+minFreq>>alpha))/CPUUtilizationPct−HeadroomPCT))*100)

where,
maxFreq=a maximum frequency,
minFreq=a minimum frequency,
alpha=a filter variable,
CPUUtilizationPct=a current CPU utilization percentage, and
HeadroomPCT=a current headroom percentage.
>>=right shift

After the EffectiveCPUUtilization is determined at block 906, the method 900 may end.

FIG. 10 illustrates a method of determining whether a filter is responding fast enough is shown and is generally designated 1000. Beginning at block 1002, a busy time variable, BusyMS, is set to (CPUUtilizationDeadline*CPUUtilizationPct)/100. At block 1004, an idle time variable, IdleMS, may be set to (CPUUtilization−BusyMS). At 1006, a performance level variable, pLevel, may be set to zero.

Moving to block 1008, a steady state filter, IIR, may be set to ((2̂(IIR_Size−alpha))−1). At block 1010, it may be determined whether IIR2Freq is greater than a maximum frequency, maxFreq. If not, the method 1000 may move to block 1012, and it may be indicated that the filter is responding within a predetermined time, e.g., it is responding fast enough. Thereafter, the method 1000 may end.

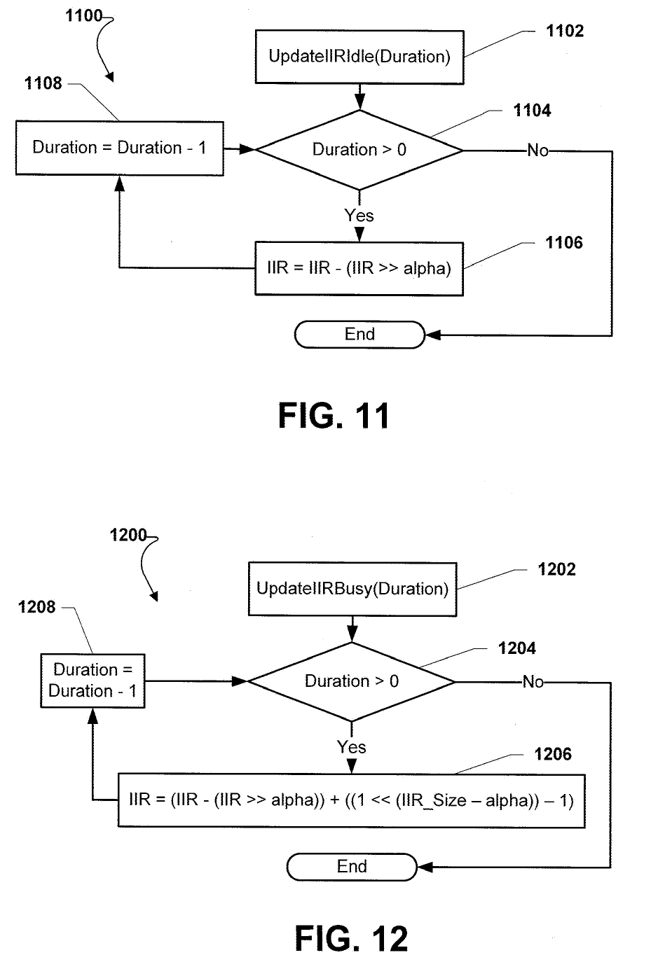

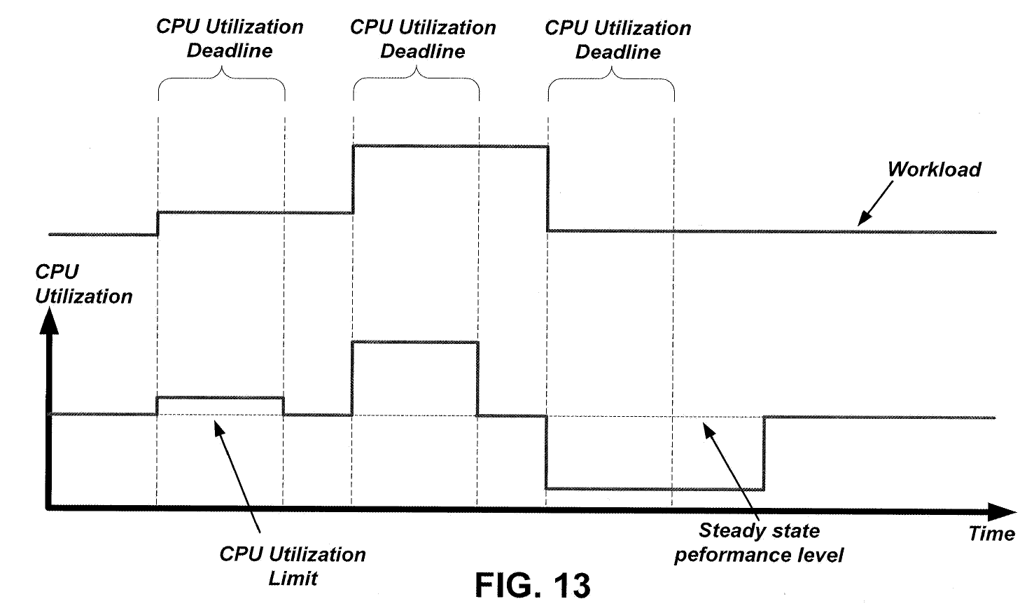

Returning to decision 1010, if IIR2Freq is less than the maximum frequency, the method 1000 may proceed to block 1014 and a steady state IIR value may be set to zero. Thereafter, it may be determined whether the BusyMS is greater than zero and IIR2Freq is less than maxFreq. If not, the method 1000 may proceed to block 1012 and the method 1000 may continue as described herein. If so, the method 1000 may proceed to decision 1018 and it may be determined whether the IdleMS is greater than zero. If so, the method 1000 may move to block 1020 and a busyPulse value is set equal to ceiling(busyMS/idleMS), where ceiling means rounding to the next highest integral value if (busyMS/idleMS) contains a non-zero fractional part. Also, an idlePulse value is set equal to ceiling(idleMS/busyMS). Thereafter, at block 1022, an UpdateIIRBusy method may be executed in order to update the steady state IIR for the integral number of busy cycles previously calculated. For example, the UpdateIIRBusy method may be the UpdateIIRBusy method shown in FIG. 12. Further, an UpdateIIRIdle method may be executed in order to update the steady state IIR for the integral number of idle cycles previously calculated. For example, the UpdateIIlRIdle method may be the UpdateIIRIdle method shown in FIG. 11. At block 1022, the BusyMS value may be reduced by a BusyPulse value and the IdleMS value may be reduced by an IdlePulse value. Thereafter, the method 1000 may return to decision 1016 and the method 1000 may continue as described herein.

FIG. 11 illustrates an UpdateIIRIdle method, generally designated 1100. The method 1100 may begin at block 1102 with a do loop in which when the UpdateIIRIdle method is executed, the following steps may be performed. At decision 1104, it may be determined if a duration variable is greater than zero. If not, the method 1100 may end. Otherwise, if the duration is greater than zero, the method 1100 may proceed to block 1106 and a filter value IIR may be reduced by IIR>>alpha (e.g., right shift the integral IIR value by alpha bits), (IIR=IIR−(IIR>>alpha). Thereafter, the method 1100 may move to block 1108 and the duration may be reduce by one integer (duration=duration−1). The method 1100 may then return to decision 1104 and continue as described herein.

FIG. 12 illustrates an UpdateIIRBusy method, generally designated 1200. The method 1200 may begin at block 1202 with a do loop in which when the UpdateIIRBusy method is executed, the following steps may be performed. At decision 1204, it may be determined if a duration variable is greater than zero. If not, the method 1200 may end. Otherwise, if the duration is greater than zero, the method 1200 may proceed to block 1206 and a filter value IIR may be determined using the following formula:

IIR=(IIR−(IIR>>alpha))+((1<<(IIR_Size−alpha))−1
wherein,
IIR=a filter value,
alpha=a variable, and
IIR_Size=a size of the IIR.
X>>Y=right shift integral value X by Y bits (i.e., X/(2̂Y))
X<<Y=left shift integral value X by Y bits (i.e., X*(2̂Y))

After IIR is determined at block 1206, the method 1200 may move to block 1208 and the duration may be reduce by one integer (duration=duration−1). The method 1200 may then return to decision 1204 and continue as described herein.

It is to be understood that the method steps described herein need not necessarily be performed in the order as described. Further, words such as “thereafter,” “then,” “next,” etc. are not intended to limit the order of the steps. These words are simply used to guide the reader through the description of the method steps. Moreover, the methods described herein are described as executable on a portable computing device (PCD). The PCD may be a mobile telephone device, a portable digital assistant device, a smartbook computing device, a netbook computing device, a laptop computing device, a desktop computing device, or a combination thereof.

The system and methods described herein provide a way to prevent the DCVS from lagging the workload too far and causing task to fail. The system and methods utilize a steady state performance guarantee. The steady state performance guarantee may be a maximum amount of time (aka deadline) that a CPU may exceed a specified CPU utilization, i.e., a busy percentage. Using the steady state performance guarantee an ad-hoc analysis of the DCVS algorithm and related performance characteristics in order to meet QoS requirements may be eliminated.

The steady state performance component may be modeled as a filter and the filter parameters may be calculated such that the responsiveness of the filter is guaranteed to meet the steady state CPU utilization limit and the steady state CPU utilization limit deadline. For example, in a particular aspect, to meet a maximum of ninety percent (90%) CPU utilization requirement in a 1000 millisecond deadline, it may be possible to configure a simple IIR filter with a 1 millisecond granularity busy/idle input with an alpha of 2⁶ (depending on the performance levels.) In a particular aspect, to determine the correct value for alpha, the filter may be set to its lowest value and then, a busy/idle chain may be executed into the filter to match the CPU utilization limit. Then for each possible alpha, the largest alpha that meets the CPU utilization deadline may be chosen.

In one or more exemplary aspects, the functions described may be implemented in hardware, software, firmware, or any combination thereof. If implemented in software, the functions may be stored on or transmitted over as one or more instructions or code on a computer program product such as a machine readable medium, i.e., a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of dynamically controlling a central processing unit, the method comprising:
determining when a CPU enters a steady state;
calculating an optimal frequency for the CPU when the CPU enters a steady state;
guaranteeing a steady state CPU utilization; and
guaranteeing a steady state CPU utilization deadline.

2. The method of claim 1, further comprising:
setting a responsiveness value to a least possible responsiveness value.

3. The method of claim 2, further comprising:
determining whether the responsiveness value is greater than a fastest possible responsiveness value.

4. The method of claim 3, further comprising:
setting a time variable equal to one, when the responsiveness is greater than the fastest possible responsiveness value.

5. The method of claim 4, further comprising:
determining whether the time variable is less than a CPU utilization deadline.

6. The method of claim 5, further comprising:
increasing the responsiveness value when the time is less than the CPU utilization deadline.

7. The method of claim 5, further comprising:
determining a steady state CPU frequency when the time variable is less than the CPU utilization deadline.

8. The method of claim 7, further comprising:
determining whether the steady state CPU frequency is greater than a maximum CPU frequency.

9. The method of claim 8, further comprising:
increasing the time variable by one integer when the steady state CPU frequency is not greater than the maximum CPU frequency.

10. The method of claim 8, further comprising:
setting a steady state responsiveness variable equal to the responsiveness value when the steady state CPU frequency is greater than the maximum CPU frequency.

11. A wireless device, comprising:
means for determining when a CPU enters a steady state;
means for calculating an optimal frequency for the CPU when the CPU enters a steady state;
means for guaranteeing a steady state CPU utilization; and
means for guaranteeing a steady state CPU utilization deadline.

12. The wireless device of claim 11, further comprising:
means for setting a responsiveness value to a least possible responsiveness value.

13. The wireless device of claim 12, further comprising:
means for determining whether the responsiveness value is greater than a fastest possible responsiveness value.

14. The wireless device of claim 13, further comprising:
means for setting a time variable equal to one, when the responsiveness is greater than the fastest possible responsiveness value.

15. The wireless device of claim 14, further comprising:
means for determining whether the time variable is less than a CPU utilization deadline.

16. The wireless device of claim 15, further comprising:
means for increasing the responsiveness value when the time is less than the CPU utilization deadline.

17. The wireless device of claim 15, further comprising:
means for determining a steady state CPU frequency when the time variable is less than the CPU utilization deadline.

18. The wireless device of claim 17, further comprising:
means for determining whether the steady state CPU frequency is greater than a maximum CPU frequency.

19. The wireless device of claim 18, further comprising:
means for increasing the time variable by one integer when the steady state CPU frequency is not greater than the maximum CPU frequency.

20. The wireless device of claim 18, further comprising:
means for setting a steady state responsiveness variable equal to the responsiveness value when the steady state CPU frequency is greater than the maximum CPU frequency.

21. A wireless device, comprising:
a processor, wherein the processor is operable to:
determine when a CPU enters a steady state;
calculate an optimal frequency for the CPU when the CPU enters a steady state;
guarantee a steady state CPU utilization; and
guarantee a steady state CPU utilization deadline.

22. The wireless device of claim 21, wherein the processor is further operable to:
set a responsiveness value to a least possible responsiveness value.

23. The wireless device of claim 22, wherein the processor is further operable to:
determine whether the responsiveness value is greater than a fastest possible responsiveness value.

24. The wireless device of claim 23, wherein the processor is further operable to:
set a time variable equal to one, when the responsiveness is greater than the fastest possible responsiveness value.

25. The wireless device of claim 24, wherein the processor is further operable to:
determine whether the time variable is less than a CPU utilization deadline.

26. The wireless device of claim 25, wherein the processor is further operable to:
increase the responsiveness value when the time is less than the CPU utilization deadline.

27. The wireless device of claim 25, wherein the processor is further operable to:
determine a steady state CPU frequency when the time variable is less than the CPU utilization deadline.

28. The wireless device of claim 27, wherein the processor is further operable to:
determine whether the steady state CPU frequency is greater than a maximum CPU frequency.

29. The wireless device of claim 28, wherein the processor is further operable to:
increase the time variable by one integer when the steady state CPU frequency is not greater than the maximum CPU frequency.

30. The wireless device of claim 28, wherein the processor is further operable to:
set a steady state responsiveness variable equal to the responsiveness value when the steady state CPU frequency is greater than the maximum CPU frequency.

31. A memory medium, comprising:
at least one instruction for determining when a CPU enters a steady state;
at least one instruction for calculating an optimal frequency for the CPU when the CPU enters a steady state;
at least one instruction for guaranteeing a steady state CPU utilization; and
at least one instruction for guaranteeing a steady state CPU utilization deadline.

32. The memory medium of claim 31, further comprising:
at least one instruction for setting a responsiveness value to a least possible responsiveness value.

33. The memory medium of claim 32, further comprising:
at least one instruction for determining whether the responsiveness value is greater than a fastest possible responsiveness value.

34. The memory medium of claim 33, further comprising:
at least one instruction for setting a time variable equal to one, when the responsiveness is greater than the fastest possible responsiveness value.

35. The memory medium of claim 34, further comprising:
at least one instruction for determining whether the time variable is less than a CPU utilization deadline.

36. The memory medium of claim 35, further comprising:
at least one instruction for increasing the responsiveness value when the time is less than the CPU utilization deadline.

37. The memory medium of claim 35, further comprising:
at least one instruction for determining a steady state CPU frequency when the time variable is less than the CPU utilization deadline.

38. The memory medium of claim 37, further comprising:
at least one instruction for determining whether the steady state CPU frequency is greater than a maximum CPU frequency.

39. The memory medium of claim 38, further comprising:
at least one instruction for increasing the time variable by one integer when the steady state CPU frequency is not greater than the maximum CPU frequency.

40. The memory medium of claim 38, further comprising:
at least one instruction for setting a steady state responsiveness variable equal to the responsiveness value when the steady state CPU frequency is greater than the maximum CPU frequency.
